(19) United States
(12) Patent Application Publication
(10) Pub. No.: US 2019/0276354 A1
(43) Pub. Date: Sep. 12, 2019

(54) GLAZING PROVIDED WITH A TEMPORARY PROTECTIVE LAYER AND WITH A PRINTED LOGO OR PATTERN

(71) Applicant: SAINT-GOBAIN GLASS FRANCE, COURBEVOIE (FR)

(72) Inventors: Elodie DUCOURTHIAL, COMPIEGNE (FR); Juliette MARIA, PARIS (FR); Christian RAVAGNANI, LONGUEIL-ANNEL (FR); Marion LALLEMENT, MARGNY LES COMPIEGNE (FR)

(21) Appl. No.: 16/334,210

(22) PCT Filed: Sep. 19, 2017
(86) PCT No.: PCT/FR2017/052497

§ 371 Date: Mar. 18, 2019

(30) Foreign Application Priority Data
Sep. 19, 2016 (FR) 1658765

(51) Int. Cl. C03C 17/42

(52) U.S. Cl. CPC C03C 17/42; C03C 2218/355; C03C 2217/78; C03C 2217/475; C03C 2218/328; C03C 2217/445

(57) ABSTRACT

A glass substrate includes on a face a water-insoluble polymeric temporary protective layer intended to be removed by heat treatment during a processing operation, and an enamel layer that has a mixture of glass frit, inorganic pigments and organic components that is deposited on at least one portion of the protective layer. The enamel has a glass transition temperature Tg above the temperature Tc₆₀%, defined as being the temperature at which 60% of the initial weight of the protective layer is consumed, a maximum shrinkage measured by thermomechanical analysis between 450° C. and 650° C. greater than 20%, a difference between the inflection point temperature T_{inflection} and the glass transition temperature Tg less than 60° C., the inflection point temperature being defined as being the temperature at which the rate of displacement measured by thermomechanical analysis of the enamel is maximum, and a content of inorganic pigments less than 35% by weight.

The present invention relates to a glass or glass-ceramic substrate comprising both a polymeric coating intended to protect it and a durable, good-quality printed logo or pattern that withstands the heat treatment during which the polymeric coating is burnt off. This type of substrate is used in the motor vehicle and building field. The process for manufacturing a substrate coated with a printed logo or pattern is also described.

For the purpose of protecting glass substrates up to the last stages of their processing, it is sometimes necessary to cover them with a protective layer, which must remain temporary and must be removed for the end use of the glass. This is in particular the case when the glass substrate comprises a functional coating intended to give it optical, thermal and/or electrical properties. Specifically, the functional coatings are based on thin layers, such as for example silver-based metallic layers, which remain fragile in particular due to a high scratchability and also may be subject to corrosion during storage, in particular in a humid environment. Patent application FR 3009302 discloses the protection of the substrate coated with a temporary protective layer of polymeric type that is insoluble in water and that is removed during a heat treatment of the coated substrate, in particular during a tempering, an annealing and/or a bending at a sufficient temperature (at least 300° C. and generally above 400° C.) to enable the removal thereof by thermal decomposition. The protective layer described in that patent application is obtained from a liquid composition comprising (meth)acrylate compounds selected from monomers, oligomers or polymers comprising at least one (meth)acrylate function, which is then cured by drying, by UV irradiation or by an electron beam. It is applied on leaving the production line for producing substrates bearing functional coatings. Thus, coated substrates are obtained that are protected from their production up until they arrive at the processor, where the substrate is cut to the desired dimensions and the final heat treatments necessary for obtaining the desired finished product are carried out. One of the standard heat treatments that these types of substrates undergo is a tempering at temperatures of at least 500° C. that makes it possible to improve the mechanical strength of the end product. Irrespective of the intended application for the glass substrate (motor vehicle or building), it is very often obligatory to mark the glazing by applying a logo directly onto the coated substrate. The printed logo or pattern must be clearly readable on the glazing and must remain so throughout the utilization time of the product. In the case of substrates coated with a temporary protective layer, the printing of the logo or design is carried out by applying a layer of enamel, generally by screen printing, directly onto the glass coated with and therefore protected by the polymeric protective layer. At the location where the logo is printed, the temporary protective layer is therefore trapped under the enamel layer, which makes the removal thereof tricky during the subsequent heat treatment intended to obtain a finished product.

The enamel used to print the logo or pattern consists of a mixture of glass frit (therefore glassy phase), inorganic pigments and organic components, which are a mixture of diluent (organic solvent) and an organic medium (usually based on resin dissolved in a solvent), which makes it possible to ensure a good suspension of all of the inorganic particles and thus the application thereof in the liquid state. In the remainder of the text, use will be made of the generic term “organic component” that includes both solvents or diluents and the organic medium. Once applied, the enamel layer may optionally be dried at a temperature below 150° C. before being fired at high temperature. The step of firing the enamel is usually carried out during the subsequent heat treatments that the coated substrate undergoes and in particular during a tempering, an annealing and/or a bending, therefore at a sufficient temperature to enable the removal of the organic components and the attachment of the inorganic particles to the substrate. During industrial processes, the drying step is often non-existent and the enamel is fired directly during the high-temperature heat treatments. When the coated substrates are protected by the temporary layer, the removal of the organic components of the enamel and the firing thereof therefore take place during the same heat treatment as that which makes it possible to remove the temporary protective layer. It has turned out that, in certain cases with standard enamels, for substrates having a temporary protective layer, defects have been observed on the finished product, therefore after firing of the enamel and removal of the temporary layer. These defects may be of various types and reveal either problems of adhesion of the enamel, that result for example in a low scratch resistance, or problems of spreading or bubbling of the enamel layer leading to a poor resolution of the printed logo or pattern on the finished product after high-temperature heat treatment.

It was consequently necessary to resolve these problems in order to be able to apply an enamel layer, corresponding to the desired criteria in terms of adhesion and readability of the printed pattern, on a substrate having a temporary protective layer. It is within this context that the present invention falls, the present invention relating to a substrate protected by a water-insoluble temporary protective layer, comprising an enamel layer deposited on the temporary protective layer which makes it possible, after a heat treatment for example tempering, to obtain a printed pattern on the substrate which is stable and withstands the processing steps of the glass such as annealing, bending and/or tempering during which the temporary protective layer is removed and the enamel layer is fired. The printed pattern must in fact have clear readability and its adhesion to the substrate must withstand the machines used for the washing.

The invention relates to a glass or glass-ceramic substrate comprising, on at least one portion of one of its faces, at least:
a water-insoluble polymeric temporary protective layer intended to be removed by heat treatment during a processing operation of the substrate such as an annealing, a bending and/or a tempering, and
an enamel layer consisting of a mixture of glass frit, inorganic pigments and organic components that is deposited on at least one portion of the protective layer, said enamel being characterized by the fact that:
   its glass transition temperature Tg is above the temperature Tc₆₀%, defined as being the temperature at which 60% of the initial weight of the protective layer is consumed, said Tc₆₀% being determined by thermogravimetric analysis in air,
   the maximum shrinkage of the enamel measured by thermomechanical analysis between 450° C. and 650° C. is greater than 20%,
   the difference between the inflection point temperature T_{inflection} and the glass transition temperature Tg is less than 60° C., the inflection point temperature being defined as being the temperature at which the rate of displacement measured by thermomechanical analysis of the enamel is maximum, and
   the content of inorganic pigments incorporated into the total composition of the enamel is less than 35% by weight.

It is necessary, so that the logo or pattern to be printed has good readability and sufficient adhesion with the glass substrate, to choose a certain type of enamel for printing the logo. It has in particular turned out that the specific features of the enamel, such as the glass transition temperature, the densification kinetics and the composition, were important parameters in the choice of the enamel to be used in order to resolve the problems of readability and adhesion of the pattern. The enamel used to print the logo or pattern comprises in particular vitrifiable glass frit and is consequently characterized by a glass transition temperature. Specifically, a glass frit is generally obtained from a mixture of oxides that is melted at high temperature and cooled rapidly in the form of powder or frit; the frit obtained may be brought to the liquid state by heating at a temperature above its glass transition temperature Tg. The composition of the glass frit has an influence in particular on the value of the glass transition temperature. The glass frit is dispersed in organic components that will burn off during the heat treatment that the enamel undergoes enabling the frit to be fastened in a durable manner to the glass substrate. During this heat treatment, generally carried out at temperatures above 400° C., or even above 500° C., all of the organic components present in the enamel will be consumed. The combustion takes place gradually as a function of the temperature of the heat treatment.

The temporary protective polymeric layer is consumed starting from an initial combustion temperature Tci that depends on its composition. The processing of the substrate during which the protective polymeric layer is burnt off is an annealing, tempering and/or bending type treatment. These treatments are customarily carried out at high temperatures, above 500° C., or even above 600° C. They are carried out in order to give the substrates the desired properties, for example in terms of mechanical strength, depending on the desired applications.

Tcx denotes the temperature at which x % of the initial weight of the temporary protective layer has been burnt off. Thus Tc_{60%} corresponds to the temperature at which 60% of the initial weight of the temporary protective layer has been burnt off. It is essential, in order to meet the expectations in terms of adhesion and readability of the logo, that a large amount of the temporary protective polymeric layer burns off at a temperature below the glass transition temperature of the enamel used to apply the logo. Advantageously, the enamel used within the context of the present invention is such that the temperature Tc₆₀%, at which 60% of the initial weight of the temporary protective layer has burnt off, is below the glass transition temperature Tg of the enamel.

The temperatures linked to the combustion of the organic constituents, both in the enamel (organic components) and in the temporary protective layer (polymeric film) are determined by thermogravimetric analysis (TGA) carried out in air. This analysis method makes it possible to determine the variation in weight of a product as a function of the increase in temperature. The product to be analyzed is customarily placed in a crucible, for example made of aluminum; the sample is placed in the analyzer under a stream of air, for example of 60 ml/min and the temperature varies between the ambient temperature and 600° C., at a rate of 10° C./min. This measurement makes it possible to determine a percentage of weight loss of the product analyzed as a function of the temperature and the analyzer establishes a graph that gives the variation of this weight percentage as a function of the temperature. During the temperature rise cycle up to 600° C., generally 95% of the initial weight of the organic polymer forming the temporary protective layer is burnt off. The burning temperature as a function of the percentage of product consumed is directly deduced from the graph in the case of the organic polymer forming the temporary protective layer. In the case of the enamel, the organic components are a mixture of solvent and/or diluent and of resin and the burning temperatures of these organic species are measured at the peaks of the first-order derivative of the graph.

It is also necessary to use an enamel for which the sintering is homogeneous and for which the attachment to the substrate is as continuous as possible. These features are in particular expressed by measuring the shrinkage ratio of the enamel during the firing thereof. Preferably, the enamel has a maximum shrinkage ratio, measured by thermomechanical analysis between 450° C. and 650° C., which is greater than 20%. The shrinkage ratio reflects in particular the densification of the enamel during the sintering. The densification of the enamel may be deduced by thermomechanical analysis which is, like thermogravimetric analysis, a thermal analysis technique. This analysis makes it possible to measure the dimensional variations of a sample as a function of the temperature, of the time and of a constant force applied to the sample. This technique is in particular used for determining the glass transition temperature Tg of the enamel and also the sintering temperature thereof since the sintering results in a decrease in length or in a shrinkage and a decrease in the porosity (therefore a densification). The samples are placed in the analyzer and subjected to a temperature rise, for example of 10° C./min between the ambient temperature and 650° C. under a constant force of 0.1 N. A displacement is then measured in millimeters. The curve of variation of the displacement expressed in mm as a function of the temperature exhibits a plateau (no or little dimensional variations) then a sudden decrease starting from a certain temperature which corresponds to the glass transition temperature Tg, which expresses a sizeable dimensional change in the sample starting from this precise point. The temperature starting from which a change in slope is noted on the graph corresponds to the Tg value. At high temperature, once the system is set, the dimensional variations return to zero and the curve of variation of the displacement in millimeters as a function of the temperature again exhibits a plateau. The measurement of the displacement as a function of the temperature is compared to the initial length of the sample L₀, at a determined temperature (in the present case 450° C.). The shrinkage which corresponds to the relative variation in length ΔL/L₀ is expressed as a percentage, the value L₀ corresponding to the displacement measured at 450° C. The maximum shrinkage of the enamel during the temperature rise cycle, and in particular between 450° C. and 650° C., is determined as being the percentage of densification between 450° C. (end of the initial plateau) and the maximum temperature corresponding to the final plateau for which displacement is no longer observed.

Furthermore, it is necessary to use an enamel for which the densification takes place over a narrow temperature range. Consequently, the enamel is characterized by the fact that the temperature difference between T_{inflection} and the glass transition temperature Tg is less than 60° C., the temperature T_{inflection} being defined as being the temperature at which the rate of displacement measured by thermomechanical analysis of the enamel is maximum. The temperature T_{inflection} is determined using thermomechanical analysis and corresponds to the lowest point (minimum of the peak) of the first-order derivative of the curve giving the displacement in millimeters as a function of the temperature. Thus, the shrinkage kinetics of the enamel during the heat treatment are fast enough to improve the chemical adhesion thereof to the glass substrate and the sintering thereof.

The enamel used for printing the logo is also characterized by the fact that the weight concentration of inorganic pigments is less than 35% by weight relative to the total composition of the enamel. The expression “inorganic pigments” is understood to refer to oxides that have a coloring power. Mention may for example be made of titanium oxide, zirconium oxide or tin oxide. Specifically, a limited amount of pigments makes it possible to improve the homogeneity of the enamel once it is fired. During the heat treatment, the inorganic pigment particles present in the enamel are encapsulated by the glass frit and a limited amount of particles of this type makes it possible to not disturb the adhesion of the enamel layer to the glass substrate. The weight percentage of pigments present in the enamel layer is measured by x-ray fluorescence, which enables the detection of chemical elements and semiquantitative estimation. In order to carry out this analysis, a glass-ceramic plate is covered using a film spreader with an enamel layer having a thickness measured before firing of greater than 70 μm. The enamel is then dried in the IR tunnel then is fired in the furnace at around 600° C. X-ray fluorescence consists in sending x-rays onto the sample up to a power of 4 kW, with angular scanning of goniometer. The gases used for the detectors are a mixture of argon and methane. Within the context of the present invention, the weight percentage of pigments given corresponds to the sum of all the pigments contained in the enamel. It is a total weight percentage of the pigments incorporated into the composition of the enamel.

The glass frit of the enamel may for example be made of a bismuth borosilicate or of a zinc borosilicate. Depending on the composition of the polymeric layer and on its combustion behavior, the composition of the frit may be adapted. Zinc borosilicates generally have a higher Tg than that of bismuth borosilicates and therefore will generally be preferred. The addition of silica and alumina has the effect of increasing the Tg of the frit, while boron oxide and alkali metal oxides make it possible to reduce the Tg.

During the heat treatment that the substrate undergoes and which is carried out at a temperature generally above 400° C. making it possible in particular to remove the temporary protective layer and to fire the enamel layer, the organic components of the enamel burn off over a temperature range lower than the temperature range for burning off the temporary protective layer. The softening and the sintering of the glass frit that is incorporated into the composition of the enamel take place at a higher temperature than the temperature at which a large amount (at least 60% of the initial weight of the temporary protective layer, preferentially at least 75% and more preferentially still at least 85%) is consumed. Thus, the enamel layer retains a sufficient porosity that enables a good combustion and the removal of the temporary protective layer trapped underneath the enamel layer. The glass transition and the sintering of the enamel appear after having burnt off at least 60% of the initial weight of the temporary protective layer, preferentially at least 75% of its initial weight and more preferentially still at least 85% of its initial weight, which enables the enamel to have a sufficient contact area with the glass substrate. The adhesion of the printed logo or pattern, after heat treatment, is thus significantly improved.

The substrate according to the present invention comprises a temporary protective layer which is a polymeric film, that is caused to disappear during the glass processing heat treatments. The temperature starting from which the combustion is initiated is referred to in the invention as the “initial combustion temperature” and is denoted by Tci, and is dependent on the chemical composition of the protective polymeric layer.

The temporary protective layer is based on a water-insoluble polymer.

The temporary protective layer may for example be a layer obtained by curing a liquid composition comprising (meth)acrylate or polyurethane compounds. This type of layer is in particular described in patent application FR 3009302 and is obtained from monofunctional and polyfunctional (meth)acrylates such as the mono-, di-, tri- and poly-functional (meth)acrylates. The liquid composition that makes it possible to obtain the polymeric layer may for example comprise an aliphatic urethane-acrylic oligomer, a mono-, di- and/or tri-functional (meth)acrylate monomer and a polymerization initiator.

The thickness of the temporary protective layer, measured after polymerization and curing, is between 1 and 30 μm. Advantageously, it is between 2 and 25 μm and more preferentially still between 5 and 20 μm. If the layer is too thick, the adhesion of the enamel layer is rendered problematic and the readability of the logo does not meet expectations.

Generally, 60% of the weight of the organic components present in the enamel layer burn off during the heat treatment, before reaching the initial combustion temperature of the protective polymeric layer. The amount of organic components of the enamel that have burnt off before reaching this temperature represents even 75%, or 85% of the weight of the organic components of the enamel.

Preferably, the enamel is characterized by the fact that its glass transition temperature Tg is above the temperature Tc_{75%}, defined as being the temperature at which 75% of the initial weight of the protective layer is consumed, Tc_{75%} being determined by thermogravimetric analysis in air.

More preferentially still, the enamel is characterized by the fact that its glass transition temperature Tg is above the temperature Tc_{85%}, defined as being the temperature at which 85% of the initial weight of the protective layer is consumed, Tc_{85%} being determined by thermogravimetric analysis in air.

Preferably, the enamel is densified over a temperature range range such that the temperature difference between T_{inflection} and the glass transition temperature Tg is less than or equal to 50° C., the temperature T_{inflection} being defined as the temperature at which the rate of displacement measured by thermomechanical analysis of the enamel is maximum.

Preferentially, the enamel layer comprises less than 20% by weight of pigments relative to the total composition of the enamel.

It is also preferable that the enamel layer comprises less than 45% by weight of organic components present in the enamel relative to the total sum of the constituents of the enamel. Preferably, the amount of organic components present in the enamel is less than 35% by weight and more preferentially still less than 30% by weight relative to the total sum of the constituents of the enamel.

The substrate according to the present invention is a glass or glass-ceramic substrate. According to one embodiment, the substrate according to the present invention comprises a functional coating on the glass or on the glass-ceramic, underneath the temporary protective layer. This coating is intended to give the substrate optical properties (mirror or anti-reflection layers), thermal properties (low-emissivity, solar-control or solar-protection layers) or electrical properties (transparent conductive layers, antistatic layers, electrochromic layers).

The substrate according to the present invention may for example be manufactured by applying, in a first step, on at least one portion of the glass substrate, a composition capable of forming the temporary protective layer by crosslinking or polymerization. This composition may for example be a liquid composition comprising methacrylate compounds. A second step consists in printing the logo or pattern by printing, directly onto the temporary protective layer, an enamel paste, deposited by screen printing, the viscosity of the enamel measured at 20° C. being between 5 and 50 Pa·s. Preferably, the viscosity of the enamel paste is between 10 and 40 Pa·s, and more preferentially still between 15 and 20 Pa·s. The viscosity measurements of enamel pastes are measured using a Haake™ Viscotester™ 550 type rotational viscometer, at a temperature of 20° C., equipped with an E30 cylinder spindle (speed of rotation 23 rpm). The enamel paste used for printing the logo corresponds to the features described above, in terms of amount of organic components (content of less than 45% by weight relative to the total sum of the constituents of the enamel paste) and in terms of physicochemical properties (the glass transition temperature Tg of the enamel is above the temperature Tc_{60%}, measured by thermogravimetric analysis in air and defined as being the temperature at which 60% of the initial weight of the temporary protective layer is consumed).

Before each application, the enamel paste must be vigorously mixed in order to guarantee a good homogeneity of the paste before application. The mixture is for example mixed with a spatula. If several printing steps are necessary for printing the logo, a step of mixing and homogenizing the enamel paste before each printing step is required.

The enamel paste is applied to the temporary protective layer through a screen printing screen which is composed of a frame over which a fabric is stretched, the mesh of which is put under a tension for example of between 10 and 20 N, with a grid pattern of for example between 77 and 120 yarns/cm. The diameter of the yarns is customarily between 0.34 and 0.55 μm. The printing by screen printing is carried out through the screen, using a squeegee that comes into contact with the substrate to be printed owing to the elasticity of the mesh. Preferably, a squeegee with a Shore hardness of between 60 and 95 is used to carry out the printing by screen printing step in order to ensure contact between the substrate and the layer of enamel paste be applied.

The present invention also relates to a process for manufacturing a glass or glass-ceramic substrate on which a logo or pattern is printed, comprising a step of heat treatment, at a temperature above 400° C., of the substrate as described above.

The heat treatment is preferably a tempering.

The examples below illustrate the invention without limiting the scope thereof.

The glass substrates used below are glass substrates of around 6 mm thick obtained by a float process that consists in pouring the molten glass onto a bath of tin.

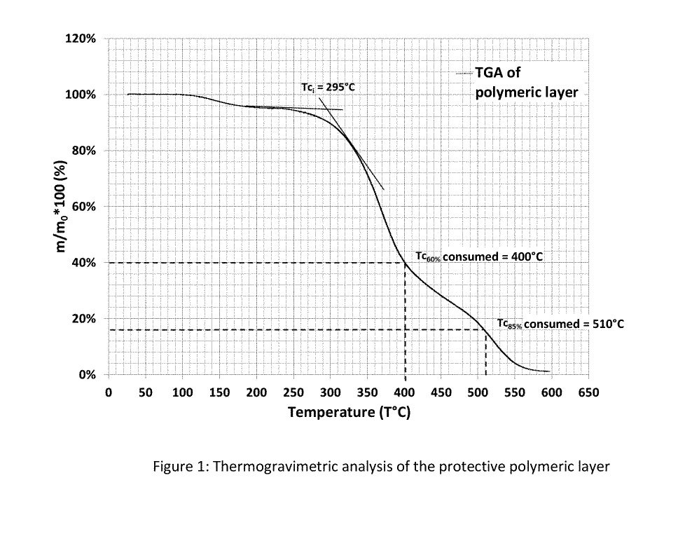

A protective polymeric film is obtained by curing a liquid composition based on oligomers and monomers comprising at least one acrylate function, sold by the company Sartomer. The liquid composition is a mixture of CN9276 (tetrafunctional aliphatic urethane-acrylate oligomer), SR351 (trimethylolpropane triacrylate), and SR833S (tricyclodecane dimethanol diacrylate) and is described in application FR3009302. This film deposited on the glass substrate corresponds to the temporary protective layer. A thermogravimetric analysis (TGA) of this film is carried out by placing 2 mg of polymer scraped off the surface of a glass substrate covered with the polymeric film into a platinum crucible. The sample is placed in the analyzer (TGA Q50 from TA Instrument) under an air flow of 60 ml/min and is heated between 20° C. and 600° C., by increasing the temperature by 10° C./min. The analyzer measures the weight variation of the sample as a function of the temperature. The curve obtained is given in FIG. 1. It is noted that the initial combustion temperature Tci of this polymeric layer is 295° C.

The temperatures Tc_{60%}, Tc_{75%} and Tc_{85%} of the polymeric film constituting the temporary protective layer are respectively equal to 400° C., 465° C. and 510° C.

Screen printing tests were carried out using various enamels (enamels 1 to 6), the features of which are given below. The enamels 1 (enamel 194020 from the company Ferro), 2 (enamel DV775370 from the company PMI), 5, and 6 (enamel 194011 from the company Ferro) contain zinc borosilicate frits and the enamels 3 (enamel 194120 from the company Ferro) and 4 contain bismuth borosilicate frits.

The analyses carried out on the enamels are the following:
thermomechanical analysis (TMA) with a TMA4000 analyzer from Perkin Elmer,
thermogravimetric analysis (TGA) with a Q50 analyzer from TA Instrument to determine the content of organic components of the enamel,
x-ray fluorescence to determine the total weight percentage of pigment in the enamel composition, carried out with a PANalytical Axios analyzer.

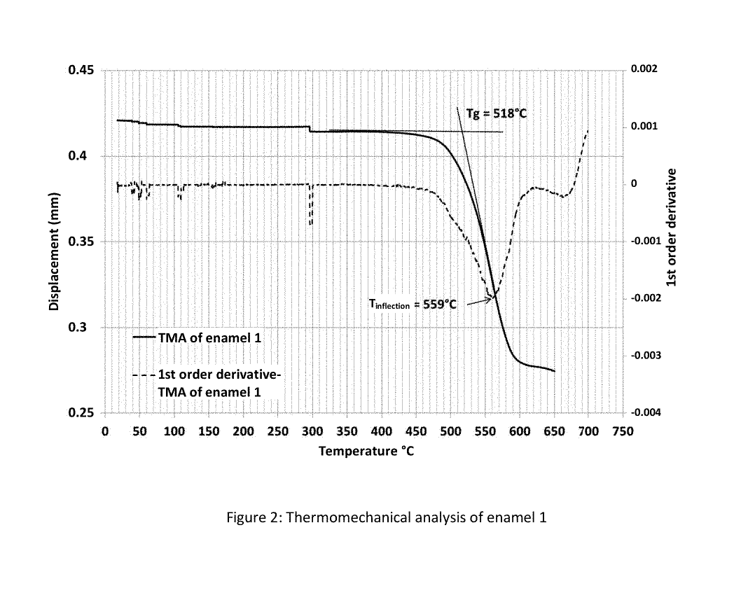

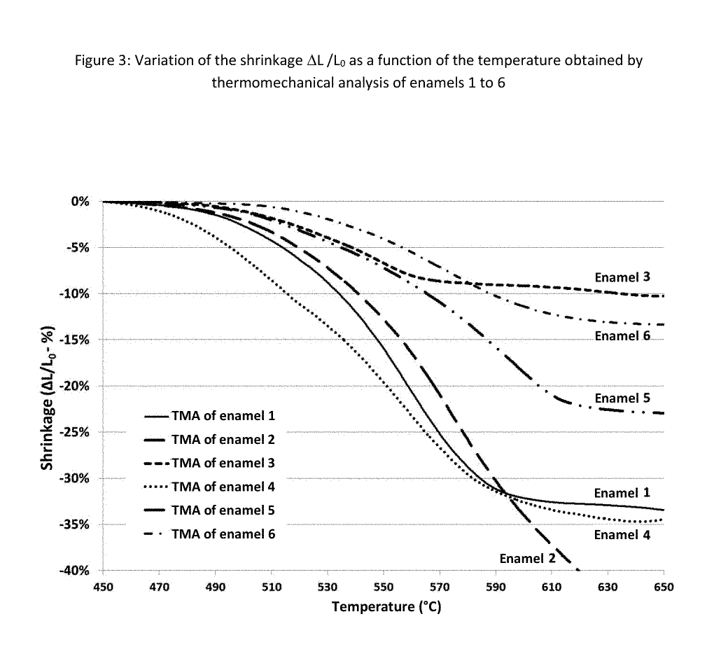

For the thermomechanical analysis, a sample of powdered enamel is prepared in the form of a 25 mg pellet. The organic constituents (organic medium) of the enamel were previously dried and burnt off in a radiative furnace at 450° C. The pellets are prepared in a hydraulic press under 4 N of pressure in a 6 mm diameter cylinder. The pellet is then placed in the analyzer between two 6 mm diameter quartz disks with a height of 1 mm. The temperature is then increased from 20° C. to 650° C. at a rate of 10° C./min under a constant pressure of 0.1 N applied to the sample. The curve representing the measurement of displacement (in mm) as a function of the temperature and also the first-order derivative of this curve are given in FIG. 2 for enamel 1. It is deduced from these curves that the glass transition temperature of enamel 1 is equal to 518° C. and that the temperature T_{inflection} at which the rate of displacement is maximum is equal to 559° C. The variations in the shrinkage of the enamel as a function of the temperature may also be measured from this analysis. The curves of variation in the shrinkage as a function of the temperature that are obtained for the various enamels tested are given in FIG. 3.

The characteristic temperatures of the various enamels tested are grouped together in the table below:

| | Enamel | Enamel | Enamel | Enamel | Enamel | Enamel |
|---|---|---|---|---|---|---|
| | 1 | 2 | 3 | 4 | 5 | 6 |
| Tg (° C.) | 518 | 527 | 505 | 496 | 532 | 533 |
| T_{inflection} (° C.) | 559 | 571 | 549 | 560 | 598 | 575 |
| T_{inflection} − Tg | 41 | 44 | 44 | 64 | 66 | 42 |
| (° C.) | | | | | | |
| maximum | 33% | 49% | 10% | 35% | 23% | 13% |
| shrinkage in % | | | | | | |
| (measured | | | | | | |
| between | | | | | | |
| 450° C. | | | | | | |
| and 650° C.) | | | | | | |
| % by weight of | 7% | 9% | 4% | 3% | 37% | 40% |
| inorganic | | | | | | |
| pigments in the | | | | | | |
| composition of | | | | | | |
| the enamel | | | | | | |

Enamels 1 to 6 have a content of organic components of less than 45% by weight relative to the total composition of the enamel.

A layer of each of the various enamels is deposited by screen printing on the substrates coated with the protective polymeric layer described above.

The samples below were produced by depositing enamel by screen printing in an air-conditioned room, using a screen with a mesh of 77.55 and a squeegee with a Shore hardness of 65. The enamels were mixed and brought to a viscosity of 15 Pa·s at 20° C. upstream of the deposition. The samples thus enameled are dried in an IR dryer brought to a set point of 160° C. before undergoing a tempering heat treatment in a radiative and convective furnace at 690° C. The enameled patterns are printed onto the glass substrate in the form of a strip of around 17 mm and a square with sides of around 6 mm.

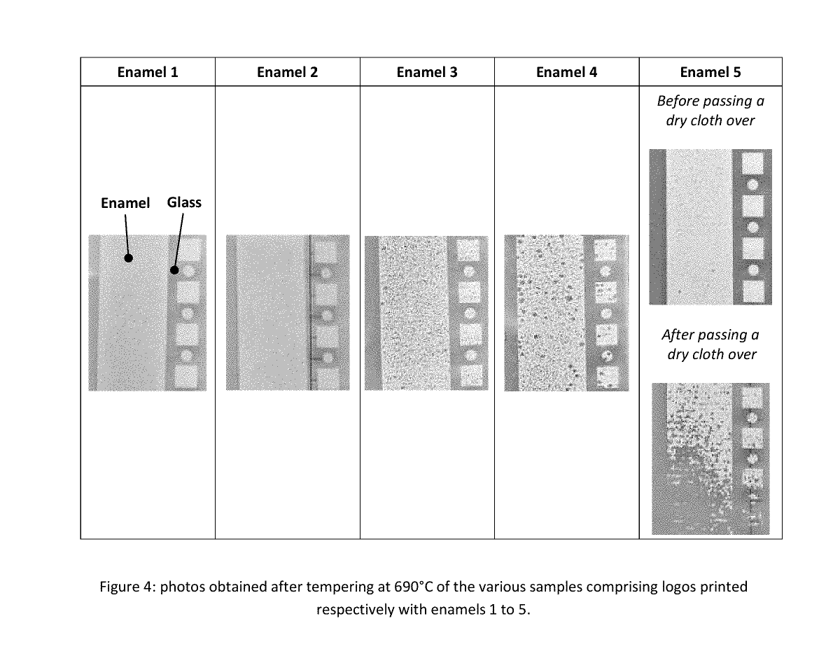

The products are then analyzed once the enamel is fired, therefore after having undergone a tempering treatment at a temperature of 690° during which the temporary protective polymeric layer is consumed and the enameled pattern is attached to the glass substrate. Photos taken face-on of each of the samples are given in FIG. 4. The photos obtained for the samples with enamels 1 to 4 remain identical before and after passing a dry cloth over the printed logo, unlike what is observed for the sample obtained with enamels 5 and 6.

The samples that respectively comprise the enamel 1 or 2 are in accordance with the invention whereas those that comprise one of the enamels 3 to 6 are given by way of comparison. The samples comprising the enamels 1 and 2 have both a good adhesion of the enamel and a good readability of the logo.

On the other hand, the samples comprising the enamels 3 to 6 do not give satisfactory results. Enamel 3 has too small a shrinkage, which leads to a heterogeneous sintering. Enamel 4 has a temperature T_{inflection} that is too far away from its glass transition temperature Tg (T_{inflection}−T_{g} of 64° C.). Its densification is too slow, the sintering taking place too rapidly. Enamels 3 and 4 additionally have a glass transition temperature close to the combustion of the protective polymeric layer: the softening of the glass frit incorporated into their composition and their densification take place while the temporary protective polymeric layer is not yet sufficiently consumed. This results in particular in the appearance of bubbles in the enamel layer. Residues of unburnt organic matter originating from the polymeric layer are interposed between the glass substrate and the densified enamel, leading to a poor adhesion thereof.

Enamel 5 given by way of comparison has both a large amount of inorganic pigments in its composition (37% by weight relative to the total composition) and also a temperature T_{inflection} that is too far away from its glass transition temperature Tg (T_{inflection}−T_{g} of 66° C.). This enamel has slow kinetics of shrinkage and therefore of densification and a sintering which takes place too late relative to its firing cycle. The presence of a large amount of pigments incorporated into the composition of the enamel disturbs the attachment of the glass frit on the substrate and results in a poor adhesion of the enamel layer.

Enamel 6, also given by way of comparison, also has too large an amount of pigments (40%), and also too low a shrinkage. The adhesion to the substrate is very poor.

1. A glass or glass-ceramic substrate comprising, on at least one portion of one of its faces:
a water-insoluble polymeric temporary protective layer intended to be removed by heat treatment during a processing operation of the substrate, and
an enamel layer consisting of a mixture of glass frit, inorganic pigments and organic components that is deposited on at least one portion of the water-insoluble polymeric temporary protective layer, said enamel having:
a glass transition temperature Tg that is above the temperature Tc_{60%}, defined as being the temperature at which 60% of the initial weight of the protective layer is consumed, said temperature Tc₆₀% being determined by thermogravimetric analysis in air,
a maximum shrinkage measured by thermomechanical analysis between 450° C. and 650° C. that is greater than 20%,
a difference between the inflection point temperature T_{inflection} and the glass transition temperature Tg that is less than 60° C., the inflection point temperature being defined as being the temperature at which the rate of displacement measured by thermomechanical analysis of the enamel is maximum, and
a content of inorganic pigments incorporated into a total composition of the enamel that is less than 35% by weight.

2. The substrate as claimed in claim 1, wherein the glass transition temperature Tg of the enamel is above the temperature Tc_{75%}, defined as being the temperature at which 75% of the initial weight of the protective layer is consumed, Tc_{75%} being determined by thermogravimetric analysis in air.

3. The substrate as claimed in claim 1, wherein the glass transition temperature Tg of the enamel is above the temperature Tc_{85%}, defined as being the temperature at which 85% of the initial weight of the protective layer is consumed, Tc_{85%} being determined by thermogravimetric analysis in air.

4. The substrate as claimed in claim 1, wherein the enamel is densified over a temperature range such that the temperature difference between T_{inflection} and the glass transition temperature Tg is less than or equal to 50° C.

5. The substrate as claimed in claim 1, wherein the enamel layer comprises less than 20% by weight of pigments relative to the total composition of the enamel.

6. The substrate as claimed in claim 1, wherein the enamel layer comprises less than 45% by weight of organic components relative to the total composition of the enamel.

7. The substrate as claimed in claim 1, wherein the temporary protective layer is obtained by curing a liquid composition comprising (meth)acrylate compounds.

8. The substrate as claimed in claim 7, wherein the liquid composition that makes it possible to obtain the polymeric layer comprises an aliphatic urethane-acrylic oligomer, a mono-, di- and/or tri-functional (meth)acrylate monomer and a polymerization initiator.

9. The substrate as claimed in claim 7, wherein the thickness of the water-insoluble polymeric temporary protective layer is between 1 and 30 μm.

10. The substrate as claimed in claim 9, wherein the thickness of the water-insoluble polymeric temporary protective layer is between 5 and 20 μm.

11. The substrate as claimed in claim 1, further comprising a functional coating on the glass or the glass-ceramic, underneath the water-insoluble polymeric temporary protective layer.

12. The substrate as claimed in claim 1, wherein the enamel layer forms a logo or a pattern.

13. A process for manufacturing a glass or glass-ceramic substrate on which a logo or pattern is printed, comprising heat treating, at a temperature above 400° C., the substrate as claimed in claim 1.

14. The process as claimed in claim 13, wherein the heat treatment is a tempering.

15. The substrate as claimed in claim 1, wherein the processing operation of the substrate is an annealing, a bending and/or a tempering.

16. The substrate as claimed in claim 6, wherein the enamel layer comprises less than 35% by weight of organic components relative to the total composition of the enamel.

17. The substrate as claimed in claim 16, wherein the enamel layer comprises less than 30% by weight of organic components relative to the total composition of the enamel.

18. The substrate as claimed in claim 9, wherein the thickness of the water-insoluble polymeric temporary protective layer is between 2 and 25 μm.
